(19) United States
(12) Patent Application Publication
(10) Pub. No.: US 2020/0282615 A1
(43) Pub. Date: Sep. 10, 2020

(54) INJECTION MOLDING PROCESS CONTROL METHOD OF MULTI-COLOR INJECTION MOLDING MACHINE

(71) Applicant: HWA CHIN MACHINERY FACTORY CO., LTD., Tainan City (TW)

(72) Inventor: Ching Kun YANG, Tainan City (TW)

(21) Appl. No.: 16/292,632

(22) Filed: Mar. 5, 2019

(51) Int. Cl. B29C 45/16; B29C 45/17

(52) U.S. Cl. CPC B29C 45/162; B29C 2045/1621; B29C 45/17

(57) ABSTRACT

Disclosed is an injection molding process control method of a multi-color injection molding machine, and its automated process setting includes a mold-opening ending process setting and a mold-closing ending process setting. The mold-opening ending process setting includes a multiple of action options sequentially carried out after a setting is selected from the mold-opening ending automated process option, and the mold-closing ending process setting is a setting selected from the mold-closing ending automated process option according to each switching action, so that the multi-color injection molding machine can use a page of the automated process setting together with the desired action option to click and select a setting according to different injection molding objects or molds, so as to complete the correction and setting of the injection stroke quickly and improve the operational efficiency of the injection molding.

### FIELD OF THE INVENTION

The present invention generally relates to an injection molding process control method, and more particularly to the method applied to a multi-color injection molding machine and capable of completing the settings for an injection process quickly according to the requirements of different molds.

### BACKGROUND OF THE INVENTION

With reference to FIG. 1 for a general injection molding machine before carrying out an injection operation, a basic control process requires the settings including a status monitoring S100, a temperature setting S101, an opening/clamping setting S102, a front injection/feeding setting S103, an ejection/blowing setting S104, a function/time setting S105, a production control S106, a core setting S107, a purging and injection setting S108, and a rear injection/feeding setting S109, so that the required settings displayed on a display interface of a control panel are clicked sequentially. For example, a user may enter into a status monitoring page to view a regular operation status of the machine, or enter into a temperature setting page to change the setting of heating, or enter into a mold-locking, mold-opening and mold-adjusting setting page to change the set values of the mold-locking, mold-opening and mold-adjusting, or enter into a front injection/feeding setting page to change the set values of injection, packing, feeding and ACC selection, or enter into an ejection/blowing setting page to change the set values of the ejection of the middle ejector, rotation, front edge ejector, rear edge ejector, blowing and setting options of other functions, or enter into a function/time setting page to change the set values of the functional switch window, front and rear preload, and time setting, or enter into a production control setting page to change the set values of the production record and quality control, or enter into a file management setting page to provide molding parameters to an operator in order to store and retrieve all related operator settings for the production of the mold, or enter into a core setting page to specify the core by the setting to carry out an action option according to the set positional action or arrange the glue valve into mold-closing ending, or enter into a purging and injection setting page to set the selection, number of times, seat retreat, and injection and feeding for the purging, or enter into a rear injection/feeding setting page to change the settings of injection, packing, feeding and ACC selection. From the aforementioned process, if the conventional injection molding machine wants to change the object and mold of the injection molding after completing the settings for the basic control options in order to carry out the object and mold of the injection molding, then it is necessary for the operator to click the basic control pages one by one to complete the settings. Obviously, such control method has the drawback of consuming much time and labor.

To improve the injection molding process control, the inventor of the present invention has filed an invention patent application of R.O.C. Pat. No. 1261022 entitled “Injection molding process control method of a plastic injection molding machine”. With reference to FIG. 2, the method comprises the following steps:

S200: Status monitoring, S201: Temperature setting; S202: Opening/clamping setting; S203: Front injection/feeding setting; S204: Ejection/blowing setting; S205: Function/time setting; S207: Production control; S208: Core setting; S209: Purging and injection setting; and S210: Rear injection/feeding setting, wherein the step S210 adds a step S206 for the control option of the automated process setting. In the step S206, the automated process setting page 1 together with the action option of the desired setting are provided for clicking and selecting the setting and correction of the whole stroke control (as shown in FIG. 3), so that operators and users of the plastic injection molding machine can correct and set the machine directly by themselves according to the characteristics of the production of the mold and product, so as to improve the efficiency effectively. The automated process setting S206 is inapplicable for injection molding machines with more than three colors, and is thus lack of the generality of use.

Further, U.S. Pat. No. U.S. Pat. No. 5,539,650A entitled “Method of controlling an injection molding machine based on knowledge” creates operation parameters, storage program instructions, and knowledge databases, and the method comprises the steps of: (a) selecting a menu based on a possible production sequence of a knowledge base; (b) inputting and storing the production sequence selection by an operator; (c) searching a subsequent production sequence selection from the knowledge base which is consistent with the previously stored production sequence selection inputted by the operator; (d) displaying the searched possible subsequent production sequence selection; (e) repeating the steps (b) to (d) until the interactive configuration of the production sequences is completed; (f) displaying the input mask related to the production sequence selection and the scope of related operation parameters; (g) storing the operation parameters inputted by the operator into the control unit; and (h) repeating the steps (f) and (g) until each production sequence selection has completed the interactive creation of the operation parameters of the initial production sequence.

### SUMMARY OF THE INVENTION

Therefore, it is a primary objective of the present invention to overcome the aforementioned drawback of the conventional injection molding machine that requires an operator to click the basic control pages one by one to complete the settings if the operator wants to change the object and mold of the injection molding after completing the settings for the basic control options in order to carry out the object and mold of the injection molding, and such control method consumes much time and labor.

The present invention is directed to an injection molding machine that adds control options for automated process settings through a setting interface of a control panel, so that the automated process settings are suitable for a multi-color injection molding machine to improve the operational efficiency of injection molding.

To achieve the aforementioned and other objectives, the present invention provides an injection molding process control method of a multi-color injection molding machine, and the process control method comprises a status monitoring, a temperature setting, a mold locking setting, a front injection/feeding setting, an ejection/blowing setting, a function/time setting, an automated process setting, a production control, a core setting, a purging and injection setting and a rear injection/feeding setting, characterized in that the automated process setting comprises a mold-opening ending process setting and a mold-closing ending process setting, and the mold-opening ending process setting comprises the settings of a plurality of action options of a rotation-advance ending and a rotation-retreat ending when being applied to a two-color injection molding machine, and the plurality of action options are operated sequentially after a setting is selected from the mold-opening ending automated process options, and the mold-closing ending process setting is a setting selected from a mold-closing ending automated process option according to each switching action, so as to complete the setting of the injection process. If the mold-opening ending process settings are applied to a three-color injection molding machine, these settings comprise the settings of a plurality of action options including a first rotation-advance ending, a second rotation-advance ending and a third rotation-advance ending, and the plurality of action option settings are carried out sequentially after a setting is selected from the mold-opening ending automated process option, and the mold-closing ending process setting is a setting selected from a mold-closing ending automated process option according to each switching action.

Based on the description above, the multi-color injection molding machine can use the page of the automated process setting together with the action option of the desired setting to click the setting according to different injection molding objects or molds to complete the correction and setting of the injection stroke, so as to improve the operational efficiency of the injection molding.

### BRIEF DESCRIPTION OF THE DRAWINGS

FIG. 1 is a flow chart of the settings of a conventional injection molding operation;

FIG. 2 is a flow chart of the settings of another conventional injection molding operation;

FIG. 3 is a schematic view showing a setting page of a conventional automated process;

FIGS. 4-5 are schematic views showing a setting page of an automated process in accordance with the present invention; and

FIG. 6 is a schematic view showing a setting page of an automated process in accordance with another embodiment of the present invention.

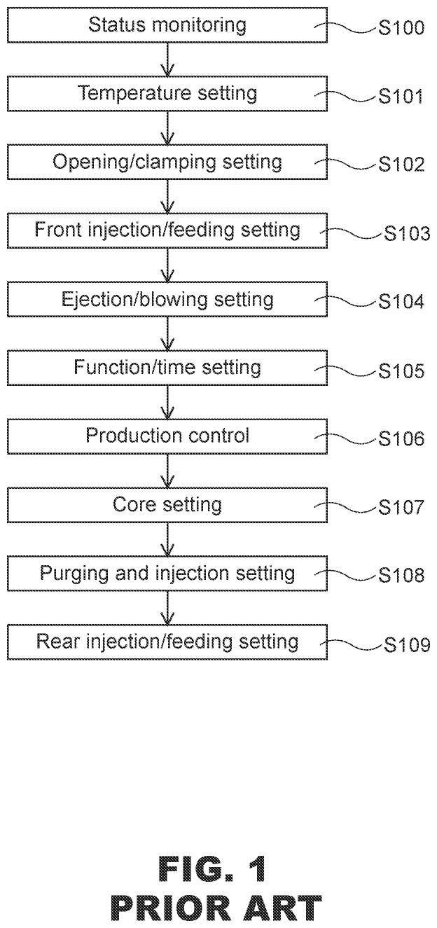

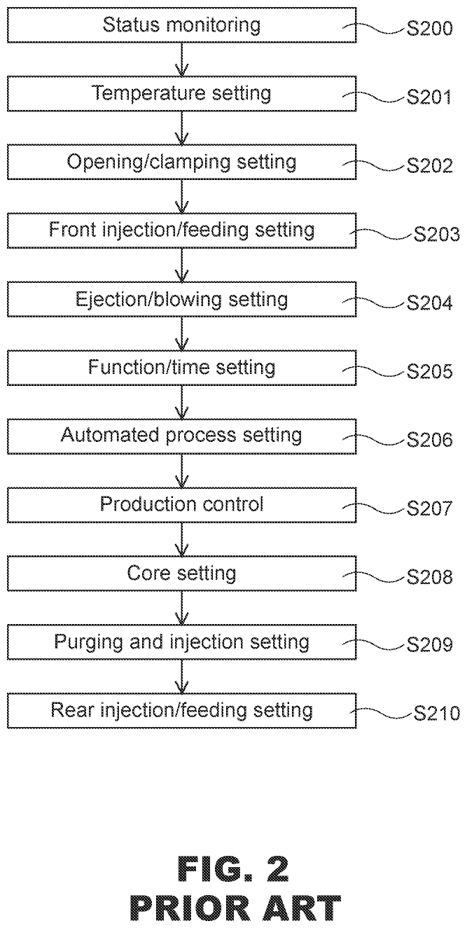

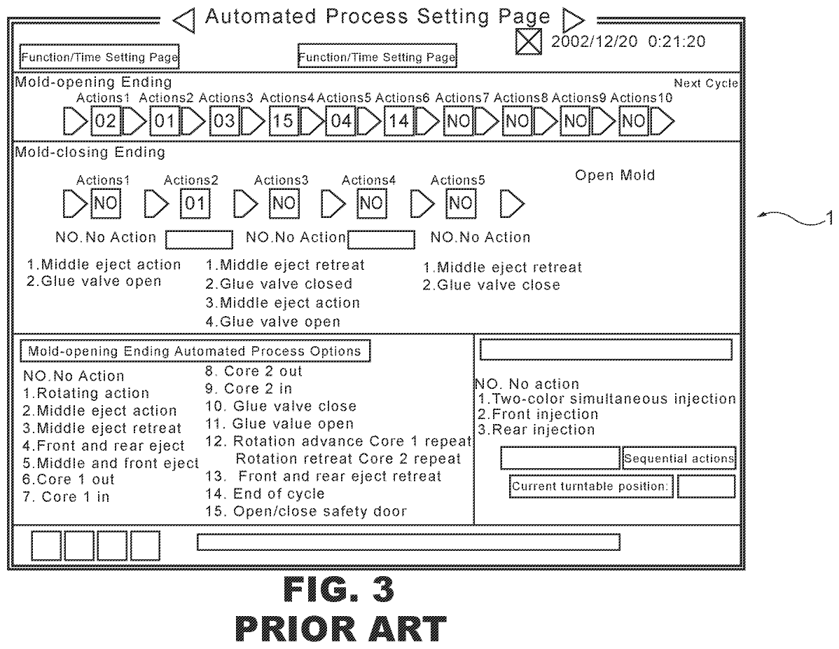

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive.

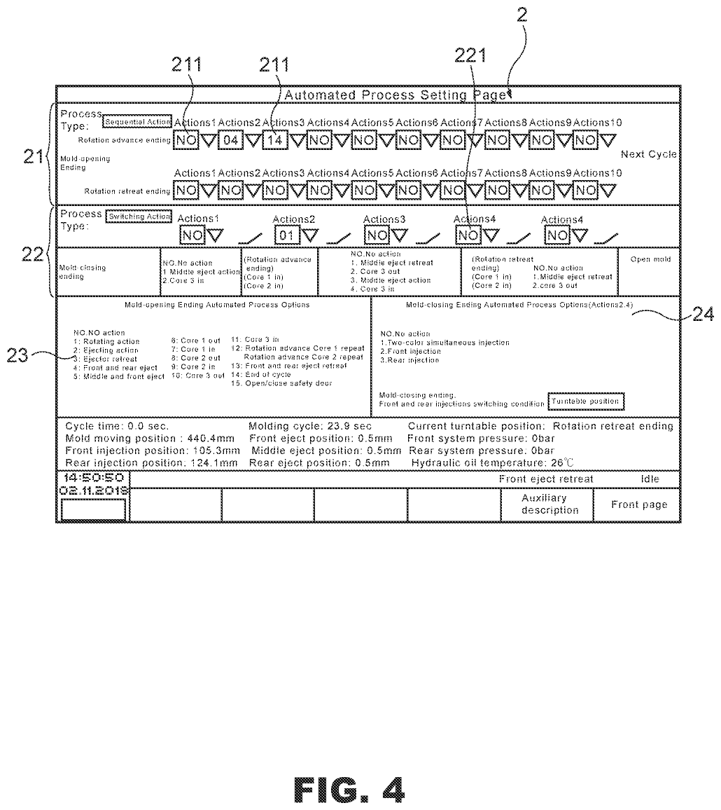

With reference to FIG. 4 for a process control method of the present invention, the process control method comprises a status monitoring, a temperature setting, a mold locking setting, a front injection/feeding setting, an ejection/blowing setting, a function/time setting, an automated process setting, a production control, a core setting, a purging and injection setting, and a rear injection/feeding setting, wherein the automated process setting 2 includes a mold-opening ending process setting 21 and a mold-closing ending process setting 22. The mold-opening ending process setting 21 is a setting selected from a mold-opening ending automated process option 23. In an embodiment of the present invention, the mold-opening ending automated process option 23 includes: NO action; 1: Rotating action (moving a support base of a male mold to rotate accordingly); 2: Ejecting action (moving the middle ejector forward, and pushing the molded product to move accordingly); 3: Ejector retreat (retreating the middle ejector with the movement); 4: Front and rear eject (The front and rear pushers will move forward with the movement to push out the molded product); 5: Middle and front eject (The middle and front pushers will move forward in correspondence with the rotation to push out the molded product); 6: Core 1 out (the Core 1 of the mold will move outwardly from the mold); 7: Core 1 in (the Core 1 of the mold will move inwardly from the mold); 8: Core 2 out (The Core 2 of the mold will move outwardly from the mold); 9: Core 2 in (The Core 2 of the mold will move inwardly from the mold; 10: Core 3 out (The Core 3 of the mold will move outwardly from the mold); 11: Core 3 in (The Core 3 of the mold will move inwardly from the mold); 12: Rotation advance Core 1 repeat, and Rotation advance Core 2 repeat (moving the support base of the male mold to rotate forward, and the core will move out and in when the support base of the male mold support base rotates backward, and when the action is carried out, the Core 2 will move out and in); 13: Front and rear ejectors retreat (The front and rear pushers will move backward); 14: End of cycle (The mold-opening ending process of the automated process ends); and 15: Open/close safety door (The safety door will be opened and then closed). The mold-closing ending process setting 22 is a setting selected from a mold-closing ending automated process option 24 according to each switching action. In an embodiment of the present invention, Action 1 of the mold-closing ending process setting 22 includes No action; 1: Ejecting action (The middle ejector will move forward to push the molded product with the movement) or 2: Core 3 in (The Core 3 of the mold will move inwardly from the mold); Action 2 and Action 4 of the mold-closing ending process setting 22 include No action; 1: Two-color simultaneous injection (the raw materials of two different colors are injected from the material pipes simultaneously); 2: Front injection (The materials are injected through the front of the mold); or 3: Rear injection (The materials are injected through the rear of the mold); Action 3 of the mold-closing ending process setting 22 include No action; 1: Ejector retreat (The middle ejector moves backward); 2: Core 3 out (The Core 3 of the mold will move outwardly from the mold); 3. Ejecting action (The middle ejector will move forward to push out the molded product with the movement); or 4: Core 3 in (The Core 3 of the mold will move inwardly from the mold); Action 5 of the mold-closing ending process setting 22 include No action; 1: Ejector retreat (The middle ejector will move backward) or 2: Core 3 out (The Core 3 of the mold will move the mold outward).

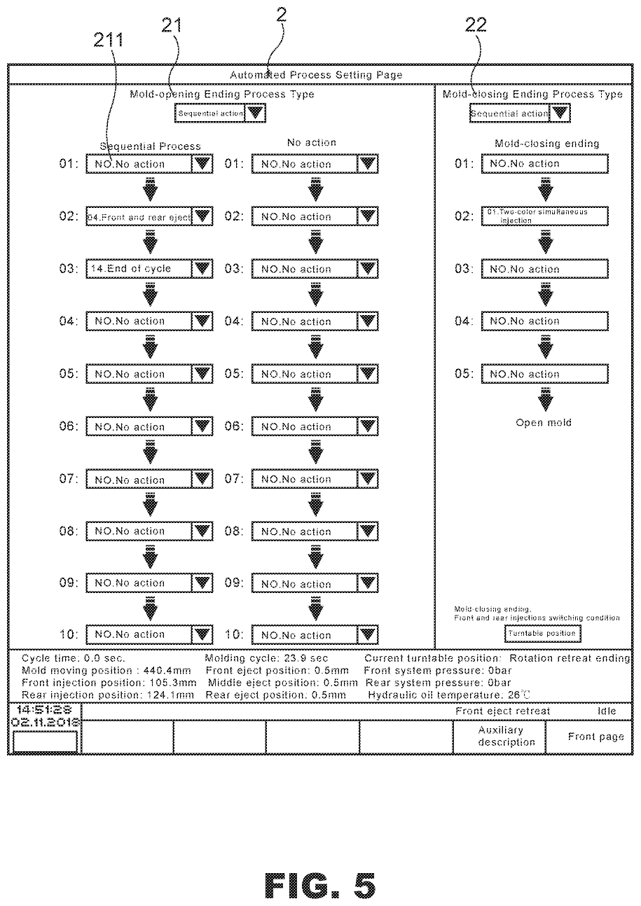

In an embodiment of the present invention as shown in FIG. 4, when the automated process setting 2 is applied to a two-color injection molding machine, its mold-opening ending process setting 21 includes a plurality of action option settings 211 of a rotation-advance ending and a rotation-retreat ending, and the plurality of action option settings 211 are carried out sequentially after a setting is selected from the mold-opening ending automated process option 23 as shown in FIG. 5. Action 1 of the rotation-advance ending action option setting 211 of the mold-opening ending process setting 21 is NO action; Action 2 is 4: Front and rear eject; Action 3 is 14: End of cycle, Actions 4 to 10 are all NO actions. Actions 1 to 10 of the rotation-retreat ending action option setting 211 are all NO actions, indicating that after the injection molding machine has completed carrying out the actions from mold-opening to mold-opening, the front and rear pusher will move forward with the movement to push out the molded product [Action 2], and then the rotation-advance ending of the automated process ends [Action 3]. Actions 1 to 10 of the rotation-retreat ending action option setting 211 of the mold-opening ending process setting 21 are all NO actions. The mold-closing ending process setting 22 is a setting selected from a mold-closing ending automated process option 24 according to each switching action, and Action 1 of the action option setting 221 of the mold-closing ending process setting 22 is NO action; Action 2 is 1: Two-color simultaneous injection; Actions 3 to 5 are all NO actions indicating that after the injection molding machine has completed executing the mold-closing to the completion of the mold-closing, the raw materials of two different raw materials are injected from the material pipes simultaneously [Action 2].

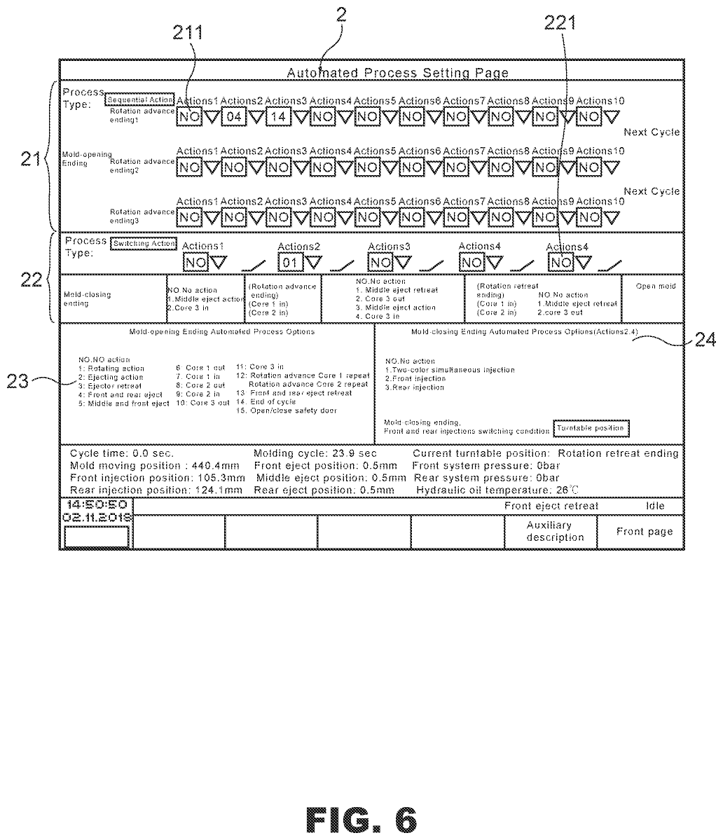

In an embodiment of the present invention as shown in FIG. 6, the automated process setting 2 is applied to a three-color injection molding machine, and its mold-opening ending process setting 21 comprises a plurality of action option settings 211 of a first rotation-advance ending, a second rotation-advance ending and a third rotation-advance ending, and the plurality of action option settings 211 are carried out sequentially after a setting is selected from a mold-opening ending automated process option 23, and the mold-closing ending process setting 22 is a setting selected from a mold-closing ending automated process option 24 according to each switching action.

Therefore, the multi-color injection molding machine can use the page of the automated process setting 2 together with the desired action option to click and select a setting according to different injection molding objects or molds to complete the correction and setting of an injection stroke quickly, so as to improve the operational efficiency of the injection molding.

What is claimed is:

1. An injection molding process control method of a multi-color injection molding machine, comprising a status monitoring, a temperature setting, a mold locking setting, a front injection/feeding setting, an ejection/blowing setting, a function/time setting, an automated process setting, a production control, a core setting, a purging and injection setting and a rear injection/feeding setting, characterized in that the automated process setting comprises a mold-opening ending process setting and a mold-closing ending process setting, and the mold-opening ending process setting comprises the settings of a plurality of action options of a rotation-advance ending and a rotation-retreat ending when being applied to a two-color injection molding machine, and the plurality of action options are operated sequentially after a setting is selected from the mold-opening ending automated process options, and the mold-closing ending process setting is a setting selected from a mold-closing ending automated process option according to each switching action, so as to complete the setting of the injection process.

2. The injection molding process control method of a multi-color injection molding machine according to claim 1, wherein the mold-opening ending automated process option comprises NO action, 1: Rotating action; 2: Ejecting action; 3: Ejector retreat; 4: front and rear eject; 5: Middle and front eject; 6: Core 1 out; 7: Core 1 in; 8: Core 2 out; 9: Core 2 in; 10: Core 3 out; 11: Core 3 in; 12: Rotation advance Core 1 repeat; 13: Rotation advance Core 2 repeat; 13: Front and rear ejectors retreat; 14: End of cycle; and 15: Open/close safety door.

3. The injection molding process control method of a multi-color injection molding machine according to claim 1, wherein the Action 1 of the mold-closing ending process setting is NO action; 1: Ejecting action; or 2: Core 3 in.

4. The injection molding process control method of a multi-color injection molding machine according to claim 1, wherein the Action 2 and Action 4 of the mold-closing ending process setting are NO action; 1: Two-color simultaneous injection; 2: Front injection; or 3: Rear injection.

5. The injection molding process control method of a multi-color injection molding machine according to claim 1, wherein the Action 3 of the mold-closing ending process setting is NO action; 1: Ejector retreat; 2: Core 3 out; 3: Ejecting action; or 4: Core 3 in.

6. The injection molding process control method of a multi-color injection molding machine according to claim 1, wherein the Action 5 of the mold-closing ending process setting is NO action; 1: Ejector retreat; or 2: Core 3 out.

7. An injection molding process control method of a multi-color injection molding machine, comprising a status monitoring, a temperature setting, a mold locking setting, a front injection/feeding setting, an ejection/blowing setting, a function/time setting, an automated process setting, production control, core setting, purging and injection setting and rear injection/feeding setting, characterized in that the automated process setting comprises a mold-opening ending process setting and a mold-closing ending process setting, and when applied to a three-color injection molding machine, the mold-opening ending process setting comprises a plurality of action option settings including a first rotation-advance ending, a second rotation-advance ending and a third rotation-advance ending, and the plurality of action option settings are carried out sequentially after a setting is selected from a mold-opening ending automated process option, and the mold-closing ending process setting selects a setting from a mold-closing ending automated process according to each switching action option, so as to complete the settings of the injection process quickly.

8. The injection molding process control method of a multi-color injection molding machine according to claim 7, wherein the mold-opening ending automated process option comprises NO action, 1: Rotating action; 2: Ejecting action; 3: Ejector retreat; 4: front and rear eject; 5: Middle and front eject; 6: Core 1 out; 7: Core 1 in; 8: Core 2 out; 9: Core 2 in; 10: Core 3 out; 11: Core 3 in; 12: Rotation advance Core 1 repeat; 13: Rotation advance Core 2 repeat; 13: Front and rear ejectors retreat; 14: End of cycle; and 15: Open/close safety door.

9. The injection molding process control method of a multi-color injection molding machine according to claim 7, wherein the Action 1 of the mold-closing ending process setting is NO action; 1: Ejecting action; or 2: Core 3 in.

10. The injection molding process control method of a multi-color injection molding machine according to claim 7, wherein the Action 2 and Action 4 of the mold-closing ending process setting are NO action; 1: Two-color simultaneous injection; 2: Front injection; or 3: Rear injection.

11. The injection molding process control method of a multi-color injection molding machine according to claim 7, wherein the Action 3 of the mold-closing ending process setting is NO action; 1: Ejector retreat; 2: Core 3 out; 3: Ejecting action; or 4: Core 3 in.

12. The injection molding process control method of a multi-color injection molding machine according to claim 7, wherein the Action 5 of the mold-closing ending process setting is NO action; 1: Ejector retreat; or 2: Core 3 out.
